(19) United States
(12) Patent Application Publication
(10) Pub. No.: US 2026/0333411 A1
(43) Pub. Date: Oct. 22, 2026

(54) METHODS, DEVICES AND SYSTEMS FOR TRI-BAND WIRELESS OPERATIONS

(71) Applicant: Cypress Semiconductor Corporation, San Jose, CA (US)

(72) Inventors: George Koruthu, Bangalore (IN); Ravi Theja Gadhamsetty, Kadapa (IN); Vinoth Sampath, Bangalore (IN); Manish Bansal, Bangalore (IN)

(73) Assignee: Cypress Semiconductor Corporation, San Jose, CA (US)

(21) Appl. No.: 19/182,305

(22) Filed: Apr. 17, 2025

(51) Int. Cl. H04W 72/563

(52) U.S. Cl. CPC H04W 72/563

(57) ABSTRACT

A method can include configuring first wireless control circuits of a first integrated circuit device (IC) to communicate according to at least a first wireless standard on a first wireless band during a first portion of a repeating operating interval, and communicate according to at least the first wireless standard on a second wireless band during a second portion of the operating interval that is different than the first portion; and configuring second wireless control circuits of a second IC in communication with the first IC to communicate according to at least the first wireless standard in a third wireless band during the first and second operating intervals. The first wireless band, second wireless band and third wireless band can be frequency ranges that do not overlap one another. Corresponding devices and systems are also disclosed.

### TECHNICAL FIELD

The present disclosure relates generally to wireless system that operate on more than one wireless band, and more particular to wireless systems that provide wireless services on three bands.

### BACKGROUND

In wireless operating environments, such as automobiles, there is a need for systems that provide wireless capabilities over three bands: the International Scientific and Medical (ISM) bands indicated for 2.4 GHz, 5 GHz and 6 GHz bands. FIG. 27 shows a conventional automobile infotainment “head” unit system 2701 that can provide tri-band operations. A conventional system 2701 can include a first integrated circuit device (IC) 2703, a second IC 2705 and a third IC 2707. The first IC 2703 can have circuits (i.e., MAC layer circuits) configured to operate as a first access point device (AP1) on the 2.4 GHz band. The second IC 2705 can have like circuits configured to operate as an AP2 on the 5 GHz band. The third IC 2707 can have like circuits configured to operate as an AP3 on the 6 GHz band.

Multiple APs (AP1, AP2, AP3) can enable various functions. For example, a device 2709-0 connected to AP1 can use a 2.4 GHz band for Internet browsing with a first IC 2703. A device 2709-1 can use a 5 GHz band to communicate with a wireless application that can be proprietary to the automobile with a second IC 2705. A device 2709-2 can use a 6 GHz band for higher speed applications, such as gaming, with a third IC 2707.

A drawback to the conventional system 2701 can be high component cost, as three different ICs must be included to service three different bands.

It would be desirable to arrive at a tri-band system that provides operations on three bands, but does not suffer from the drawbacks of conventional systems.

### SUMMARY

A method can include configuring first wireless control circuits of a first integrated circuit device (IC) to communicate according to at least a first wireless standard on a first wireless band during a first portion of a repeating operating interval. A first IC can communicate on a second wireless band during a second portion of the operating interval that is different than the first portion. Second wireless control circuits of a second IC can be in communication with the first IC. A second IC can be configured to communicate according to at least the first wireless standard in a third wireless band during the first and second operating intervals. The first wireless band, second wireless band and third wireless band can be frequency ranges that do not overlap one another. Corresponding devices and systems are also disclosed.

### BRIEF DESCRIPTION OF THE DRAWINGS

FIG. 1 is a diagram of a system according to an embodiment.

FIG. 2 is a diagram of a system according to another embodiment.

FIG. 3 is a diagram of a system according to a further embodiment.

FIG. 4 is a diagram of a system according to another embodiment.

FIG. 5-0 and 5-1 are timing diagrams showing tri-band operations according to embodiments.

FIG. 6 is a diagram showing configuration options of a system according to embodiments.

FIGS. 7-0 and 7-1 are diagrams showing system operations according to embodiments.

FIG. 8 is a diagram showing system re-configuration operations according to an embodiment.

FIGS. 9-0, 9-1 and 9-2 are diagrams showing system operations according to other embodiments.

FIGS. 10-0 and 10-1 are diagrams showing system operations according to further embodiments.

FIG. 11 is a block diagram of an integrated circuit device (IC) according to an embodiment.

FIG. 12 is a block schematic diagram of a system according to another embodiment.

FIG. 13 is a block diagram media access control (MAC) layer circuits that can be included in embodiments.

FIG. 14 is a diagram showing IC devices according to embodiments.

FIG. 15 is a diagram of a module according to an embodiment.

FIG. 16 is a flow diagram of a method according to an embodiment.

FIG. 17 is a flow diagram of a method according to another embodiment.

FIGS. 18-0 and 18-1 are flow diagrams of methods according to further embodiments.

FIG. 19 is a flow diagram of a method according to another embodiment.

FIG. 20 is a flow diagram of a method according to another embodiment.

FIG. 21 is a flow diagram of a method according to another embodiment.

FIG. 22 is a flow diagram of a method according to another embodiment.

FIG. 23 is a flow diagram of a method according to another embodiment.

FIG. 24 is a diagram of an automobile system according to an embodiment.

FIG. 25 is a diagram of an automobile system according to another embodiment.

FIG. 26 is a diagram showing Internet-of-Thing devices according to embodiments.

FIG. 27 a diagrams showing a conventional tri-band system.

### DETAILED DESCRIPTION

According to embodiments, a system can provide access communication on three different bands with the use of two integrated circuit devices (ICs). A system can operate according to a repeating time interval. A first IC can operate as an access device (e.g., access point (AP)) for a first band, during a first portion of the interval, and as an access device for a second band, during a second portion of the interval. A second IC can operate as an access device for a third band during both the first and second portions of the interval. First, second and third bands can be non-overlapping frequency ranges.

In some embodiments, a first IC can operate as an access point device (AP1) according to an IEEE 802.11 wireless standard for a first band (e.g., 2.4 GHz) in a first interval, and as another AP (AP2) for a second band (e.g., 5 or 6 GHz) in a second interval. A second IC can operate as a third AP (AP3) for a third band (6 GHz or 5 GHz) during the first and second intervals. In some embodiments, a first or second interval can correspond to a maximum channel reservation duration established by a CTS-to anywhere frame (e.g., ~16.3 ms).

According to embodiments, a system can dynamically switch an access over one band from one IC to another IC, enabling a system to adapt band use on the fly and/or in response to a system state or condition. A first IC can be in communication with a second IC via a wired connection (e.g., bus). Configuration data for an access device on a first IC can be copied to a second IC, enabling the second IC to create (or recreate) the access device from the first IC.

In some embodiments, a system can include a first IC with a media access control (MAC) layer circuits compatible with operations on a first band or second band. A second IC can include its own MAC layer circuit compatible with the first band or third band. Such MAC layer circuits can be compatible with one or more IEEE 802.11 wireless standards. Initially, a first IC can operate as an AP1 for a first band (e.g., 2.4 GHz) and an AP2 for a second band (e.g., 5 or 6 GHz), by time division multiplexing (TDM) operations between AP1 and AP2 using the same MAC layer circuit. At the same time, a second IC can operate as an AP3 for a third band (e.g., 6 or 5 GHz). Configuration for AP1 can be copied from IC1 to IC2. IC2 can then operate with TDM operations between AP1 and AP3 using the same MAC layer circuit. IC1 can then operate as an AP2 without TDM operations. The reverse operation can also occur, with IC2 transferring configuration data to IC1 to transfer an AP from IC2 to IC1.

In some embodiments, configuration data transferred between IC devices operating as IEEE 802.11 compatible APs can include MAC layer management entity (MLME) state data and encryption keys (e.g., pairwise transient key (PTK), groupwise transient key (GTK)).

According to embodiments, a system can steer a connected client device between multiple bands when the client device emits queries with unknown identification values (IDs) (e.g., MAC addresses) on the other bands. A system can maintain a connected list of device IDs for client devices connected to a first IC. A connected list can be maintained based on aging. That is, if a connection has not been made to a client device on the connected list within a predetermined time period, the device ID for the device can be removed from the connected list. When a wireless query (e.g., probe) is received at a second IC from a client device on a particular band that includes an unknown device ID, a system can issue an action request on the particular band using device IDs of the connected list. If a corresponding response (e.g., ACK) is received from a client device, the system knows the responding client device can be band steered from the first IC to the second IC, and the client device is directed to switch bands and connect to the second IC.

In some embodiments, an IEEE 802.11 compatible tri-band system can maintain a connected list containing MAC addresses of station devices (STAs) connected to an AP1 operating on a first band (e.g., 2.4 GHz). In the same or equivalent fashion noted above, STAs can age out of a connected list. A connected STA can periodically emit probe requests with random MAC addresses on one or more other bands (e.g., 5 and/or 6 GHz). If another an AP3 operating on a second band detects such a probe request, it can issue a generic advertisement service (GAS) frame to the devices on the connected list. In response to a GAS frame, the STA can return an acknowledgement (ACK). In response to such an ACK, the AP3 can issue a message to AP1 directing it to steer to the STA to its band. The AP1 can issue a basic service set (BSS) transition management (BTM) frame to the STA, steering it to the second band (e.g., 5 or 6 GHz) from the first band (e.g., 2.4 GHz).

According to embodiments, a tri-band system can execute an application that utilizes a particular band from the three possible bands. When such an application is not active, a client device capable of operating on the particular band, but not currently connected to the particular band, can be band steered from its current band to the particular band.

In some embodiments, an IEEE 802.11 compatible tri-band system can determine on which bands a connected STA is capable of operating. The system can also intermittently execute an application that utilizes a particular band (e.g., a band optimized for higher speed applications, such as 6 GHz). When the application is inactive, or otherwise not using the particular band, or using the particular band at a lower rate or throughput, a BTM frame can be issued to a STA connected to another band (e.g., 2.4 GHz or 5 GHz) but capable of operating on the particular band. The BTM frame can direct the STA to connect to the AP of the particular band.

Various embodiments will now be described with reference to the drawings.

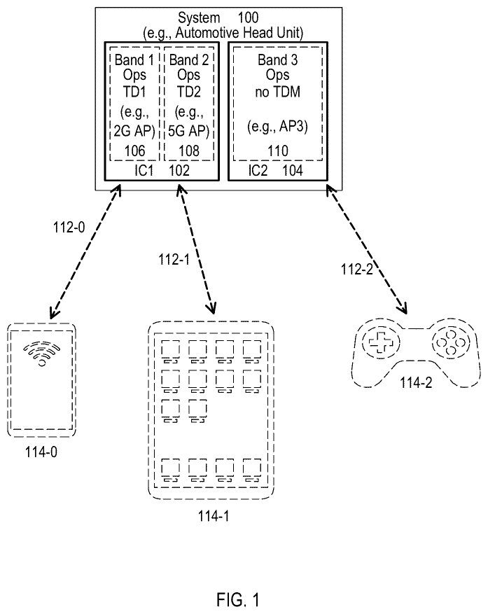

FIG. 1 is a diagram of a system 100 according to an embodiment. A system 100 can provide wireless operations on three different bands using a first IC (IC1) 102 and second IC (IC2) 104. Wireless operations on all three bands can occur during repeating time intervals. IC1 102 can provide first band operations 106 during a first time division portion (TD1) of the repeating interval, and can provide second band operations 108 during a second time division portion (TD2) of the repeating interval. In some embodiments, a TD1 and TD2 added together can make up essentially an entire interval. IC2 104 can provide third band operations 110 during the repeating interval. In some embodiments, third band operations 110 can occur over an entire interval. In some embodiments, first, second and third bands can occupy non-overlapping frequency ranges. Time multiplexing of first and second band operations (106, 108) by IC1 102 can be considered virtual simultaneous dual band operations (VSDB).

A system 100 can enable different client devices to establish connections over the three bands. FIG. 1 shows a first client device 114-0 having a first type connection 112-0 to first band operations 106, a second client device 114-1 having a second type connection 112-1 to second band operations 108, and a third client device 114-2 having a third type connection 112-2 to third band operations 110 It is understood that first client device 114-0 can communicate over connection 112-0 during TD1 of repeating intervals and second client device 114-1 can communicate over connection 112-1 during TD2 of repeating intervals. Third client device 114-2 can communicate over connection 112-2 over an entire interval.

In some embodiments, a repeating interval can include a time unit (TU) according to an appropriate standard. However, in other embodiments, a repeating time interval can include more than one TU. Still further, embodiments anticipate both regular repeating intervals (i.e., intervals of a same duration), as well as intervals that may be of different durations.

In this way a system can provide three operating bands in which one IC time multiplexes access between first and second bands during a time interval, while a second IC provides access to a third band over the same time interval.

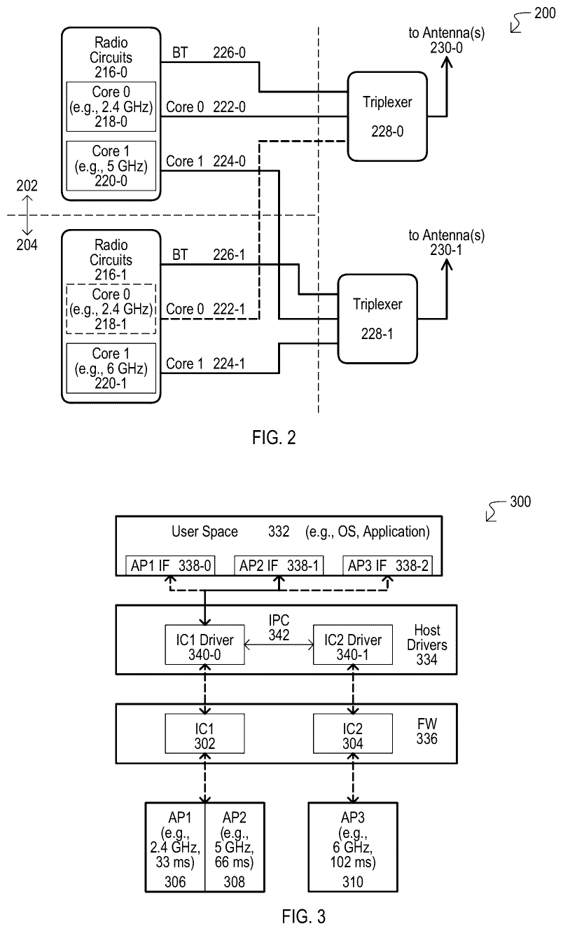

FIG. 2 is a block diagram of a system 200 according to another embodiment. In one embodiment, a system 200 can be one implementation of that shown in FIG. 1. A system 200 can include IC1 202, IC2 204, a first multiplexer 228-0 and a second multiplexer 228-1. IC1 202 and IC2 204 can each include radio circuits 216-0/216-1 to enable operations on three bands. In the embodiment shown, IC1 radio circuits 216-0 can be multi-radio circuits that can include core 0 operations 218-0 and core 1 operations 220-0. Core 0 operations 218-0 can include communications on a first band (e.g., 2.4 GHz). Core 1 operations 220-0 can include communications on a second band (e.g., 5 GHz). In some embodiments, radio circuits 216-0 can time multiplex operation between core 0 218-0 and core 1 220-0 operations. Radio circuits 216-0 can also include Bluetooth (BT) circuits (not shown) for operations according to one or more BT standards, including but not limited to BT low energy (BLE).

In the embodiment shown, IC2 radio circuits 216-1 can be multi-radio circuits that include core 1 circuits 220-1 for operations on a third band (e.g., 6 GHz) as well as BT circuits. Optionally, multi-radio circuits 216-1 can further include core 0 circuits 218-1 for operations on a first band. In such an arrangement, IC2 radio circuits 216-1 can have a mode of operation in which core 0 operations 218-1 and core 1 operations 220-1 are time multiplexed. However, in other embodiments IC2 radio circuits 216-1 can be single radio circuits that include core 1 circuits 220-1 (for third band operations), and do not include BT circuits or circuits for operations on first or second bands.

Signals for a first band can be transferred between IC1 radio circuits 216-0 and first multiplexer 228-0 by core 0 signal path 222-0. BT signals can be transferred between IC1 radio circuits 216-0 and first multiplexer 228-0 by BT signal path 226-0. Optionally, signals for a first band can be transferred between IC2 radio circuits 216-1 and first multiplexer 228-0 by second core 0 signal path 222-1. First multiplexer 228-0 can provide one or more signal paths to one or more first antenna(s) 230-0 designed for operations on a first band (e.g., 2.4 GHz).

Signal paths between IC2 radio circuits 216-1 and second multiplexer 228-1 can have a similar arrangement, with a BT signal path 226-1 and core 1 signal path 224-1. In addition, a core 1 signal path 224-0 can exist between IC1 radio circuits 216-0 and second multiplexer 228-1. Second multiplexer 228-1 can provide one or more signal paths to one or more second antennas 230-1 designed for operations on a second band and third band (e.g., 5 GHz and 6 GHz).

In this way, a system can include a first IC that can time multiplex operations on a first band and second band and a second IC providing operations on a third band. First band operations can have a signal path to first antenna system. Second and third band operations can have a multiplexed signal path to a second antenna system.

FIG. 3 is a block diagram showing a system 300 according to another embodiment. In one embodiment, a system 300 can be one implementation of that shown in FIG. 1. FIG. 3 shows a hierarchy for controlling two ICs to provide tri-band operations. A system 300 can include a user space 332, host drivers 334, firmware (FW) 336 and resulting band operations 306, 308 and 310. A user space 332 can enable requests for different access devices, which can each operate on a different band. In some embodiments, a user space 332 can include an application or operating system (OS) executed by processing circuits or the like. A user space 332 can enable requests and responses for a first access device (AP1 IF) 338-0, a second access device (AP2 IF) 338-1, and a third access device (AP3 IF) 338-2. In some embodiments, access devices requests and responses (338-0, 338-1, 338-2) can be for APs compatible with one or more IEEE 802.11 wireless standard operating on different bands

Host drivers 334 can include an IC1 driver 340-0 and IC2 driver 340-1, which can be processes executed by processing circuits of a system 300. One of IC1 or IC2 drivers (340-0 or 340-1) can be a master driver, while the other is a slave driver. IC1 and IC2 drivers (340-0 or 340-1) can communicate with one another with inter-process communications (IPC) 342. Host drivers 334 can direct requests and response between user space 332 and IC1 302 and IC2 304. Requests and response for access devices (AP1, AP2 and AP3) can be executed by FW 336 and circuits on IC1 302 and IC2 304.

In the embodiment shown, an AP1 306 and AP2 308 can be created on IC1 302 and an AP3 can be created on IC2 304. AP1 306 can operate on a first band (e.g., 2.4 GHz), AP2 308 can operate on a second band (e.g., 5 GHz) and AP3 can operate on a third band (e.g., 6 GHz). In the embodiment shown, IC1 driver 340-0 can service requests for AP1 306 or AP2 308. IC2 driver 340-1 can service requests for AP3. In the embodiment shown, IC1 302 can provide VDSB operations between AP1 306 and AP2 308. In the embodiment shown, AP1 306 can provide operations during ~36 ms of a repeating interval of ~102 ms. AP2 308 can provide operations during ~66 ms of the repeating interval, while AP3 310 can provide operations over the entire interval ~102 ms. Other durations may also be allocated to AP1 306 and AP2 308. For example, the interval allocation may vary depending on the criticality of operations being executed by AP1 306 and AP2 308.

Operations for system 300 will now be described. In such descriptions, it is assumed that IC1 driver 340-0 can be a master driver while IC2 driver 340-1 can be a slave driver. A wireless access command can be generated or received in user space 332 directed to one of AP1 306, AP2 308 or AP3 310. Such a command (i.e., request) can be received by master driver 340-0. If the command is directed to AP1 306 or AP2 308, a master driver 340-0 can create the AP using FW 336 on IC1 302. Once an AP is created, such an AP can begin broadcasting messages (e.g., beacons) to indicate its availability for connection. A command for AP1 306 can be executed by IC1 302 in a first portion of an interval, which by way of example is indicated by ~33 ms. A command for AP2 308 can be executed in a second portion of an interval by IC1 302, the second portion being indicated for example, by ~66 ms. If the command is directed to AP3, via IPC 342, master driver 340-0 can direct slave driver 340-1 to create AP3 using FW 336 on IC2 304. As noted above, once AP3 is created, it can begin broadcasting messages indicating its availability for connection.

As will be described in more detail below, while FIG. 3 indicates a first interval as ~33 ms and a second value as ~66 ms, such values can be aggregate values over a repeating interval.

In this way, wireless access commands for first or second bands can be directed to a first IC device by a master process that can control operations of the first IC device. Wireless access commands for a third band can be directed by master process to a slave process that can control operations of a second IC device.

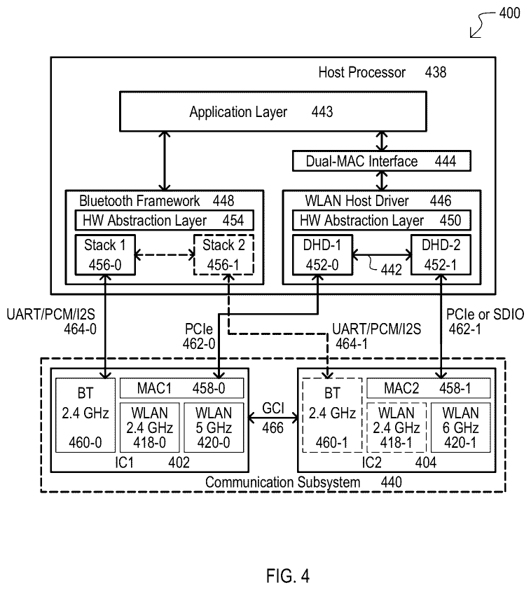

FIG. 4 is a block diagram of a system 400 according to another embodiment. In one embodiment, a system 400 can be one implementation of that shown in FIG. 1. A system 400 can include a host processor 438 and a communications subsystem 440. A host processor 438 can include one or more processor circuits and corresponding instructions (e.g., code). A host processor 438 can include an application layer 443, a dual-MAC interface 444, WLAN host driver 446 and a BT framework 448. An application layer 443 can execute one or more applications with functions that can access wireless services according to one or more IEEE 802.11 wireless standards (WLAN), as well as BT operations. A dual-MAC interface (IF) 444 can enable control and communication over two different MAC layer circuits.

A WLAN host driver 446 can include drivers capable of communicating with two different ICs, and can include a hardware (HW) abstraction layer 450, a first driver (e.g., dongle hardware driver) DHD-1 452-0 and a second driver DHD-2 452-1. In some embodiments, DHD-1 452-0 and DHD-2 can be a master driver and slave driver, as described herein or equivalents.

A BT framework 448 can enable applications to access BT functions, and can include its own HW abstraction layer 454, an execution software stack 456-0 and optionally, a second such stack 456-1.

A communication subsystem 440 can include a IC1 402 and IC2 404. A first IC 402 can include first MAC layer circuits 458-0, first WLAN circuits 418-0, second WLAN circuits 420-0, and BT circuits 460-0. First WLAN circuits 418-0 can enable wireless operations on a first band (e.g., 2.4 GHz). WLAN circuits as described herein, can enable communications according to one or more IEEE 802.11 wireless standards. Second WLAN circuits 420-0 can enable wireless operations on a second band (e.g., 5 GHz). BT circuits 460-0 can enable BT operations on the first band according to one or more BT standards.

A IC2 404 can include second MAC layer circuits 458-1, third WLAN circuits 420-1, BT circuits 460-1, and optionally, fourth WLAN circuits 418-1. Third WLAN circuits 420-1 can enable wireless operations on a third band (e.g., 6 GHz). Optional fourth WLAN circuits 418-1 can enable wireless operations on a first band. BT circuits 460-1 can enable BT operations on the first band.

In the embodiment shown, IC1 402 and IC2 404 can be in communication with one another over a wired connection 466. In the embodiment shown, communications over wired connection 466 can be compatible with a global coexistence interface (GCI) 466.

A host processor 438 can be in communication with communication subsystem 440 via one or more communication paths (e.g., buses). In the embodiment shown, DHD1 452-0 can communicate with IC1 402 over communication path 462-0, which in some embodiments can be compatible with a peripheral component interconnect express (PCIe) standard, and with IC2 404 over communication path 462-1 which can be compatible with a PCIe or a secure digital input output (SDIO) standard. A BT framework 448 can be in communication with BT circuits 460-0 of IC1 over communication path 464-0, which can be compatible with universal asynchronous receiver-transmitter (UART) type communications, a BT pulse code modulation (PCM) IF, and/or an I2S type IF. Optionally, a BT framework 448 can be in communication with BT circuits 460-1 of IC2 over communication path 464-1, which can be compatible UART type communications, a BT PCM IF, and/or an I2S IF.

In operation, signals from host processor 438 generated by DHD-1 can be transmitted to IC1 402 to configure an AP1 operating on the first band or an AP2 operating on the second band. Signals generated by DHD-2 transmitted to IC2 404 can configure an AP3 on IC2 404. Optionally, signals generated by DHD-2 can configure an AP4 operating on a first band in IC2 404, if WLAN circuits 418-1 are included.

As will be described for other embodiments herein, if an IC2 404 includes WLAN circuits 418-1, configuration data for an AP1 created on IC1 402 (using WLAN circuits 218-0) can be transferred to IC2 404 via host driver 446. IC2 404 can then re-create the AP1 (using WLAN circuits 418-1).

In this way, a system can include a host processor running applications with wireless functions can be connected to a communication subsystem over two or more communication paths. A communication subsystem can include a first IC having separate communication circuits to operate on a first band and a second band. A second IC can include communication circuits to operate on a third band.

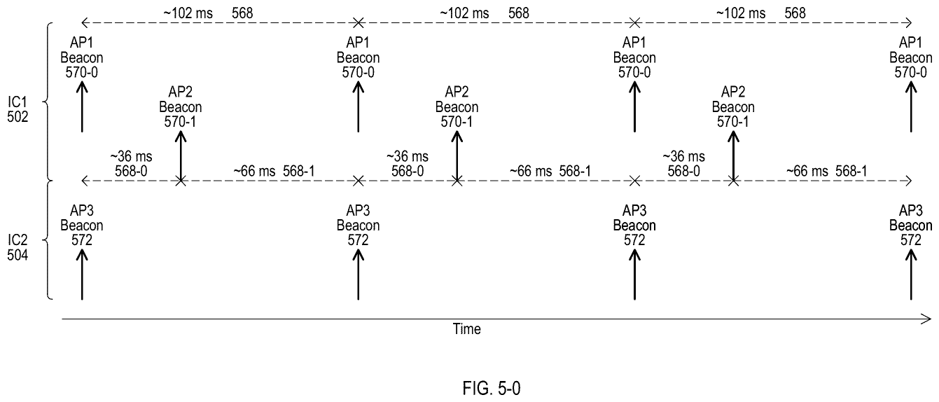

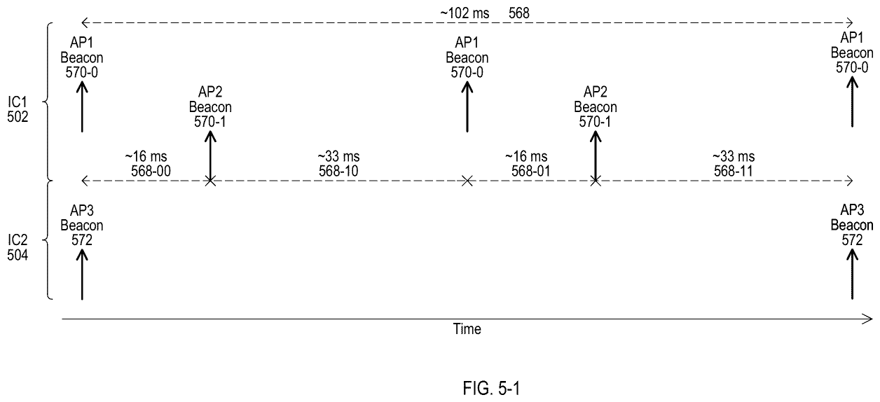

FIG. 5-0 is a timing diagram showing tri-band operations according to an embodiment. FIG. 5-0 shows operations of a system having an IC1 502 that can create an AP1 operating on a first band (e.g., 2.4 GHz) and an AP2 operating on a second band (e.g., 5 GHz) and an IC2 504 that can create an AP3 operating on a third band (e.g., 6 GHz).

Operations can occur according to repeating time intervals 568, with each AP periodically issuing a beacon for each interval. In some embodiments, an interval can be a TU according to an IEEE 802.1.1 wireless standard (e.g., ~102 ms).

IC1 502 can provide dual band operations by creating an AP1 for a first band and an AP2 for a second band. In the embodiment shown, AP1 and AP2 can be compatible with one or more IEEE 802.11 standards that include issuing beacons. AP1 beacons 570-0 can be issued on a first band, indicating a first portion 568-0 of an interval 568 in which AP1 can operate on the first band. Subsequently, AP2 beacons 570-1 can be issued, indicating a second portion 568-1 of an interval 568 in which AP2 can operate on the second band. AP3 can issue AP3 beacons 572 at the start of each interval indicating it can operate on a third band during the interval 568. In some embodiments, beacons 570-0, 570-1 and 572 can be transmitted according to an IEEE 802.11 wireless standard. It is understood that the interval portions 568-0 and 568-1 can be aggregate values, each reflecting more than one sub-intervals during which the corresponding AP is active.

FIG. 5-1 is a timing diagram showing time multiplexed APs of a same IC device operating during multiple sub-intervals of an interval. FIG. 5-1 shows items like those of FIG. 5-0, and such like items are referred by the same reference characters.

FIG. 5-1 differs from FIG. 5-0 in that AP1 and AP2 operate during alternating sub-intervals. AP1 can issue a beacon 570-00 at the start of, and operate during, a first sub-interval 568-00. This can be followed by AP2 issuing a beacon 570-10, and operating during a second sub-interval. This process can repeat with AP1 operating during a third sub-interval 568-01 and AP2 operating during a fourth sub-interval 568-11. In some embodiments, smaller sub-intervals 568-00, 568-01 can correspond to a maximum duration of a CTS-to-anywhere frame (~16.4 ms).

In this way, a system can include a first IC that issues beacons for first and second APs during a wireless operating interval for different portions of a wireless operating interval, and a second IC that issues a beacon for a third AP during the same interval.

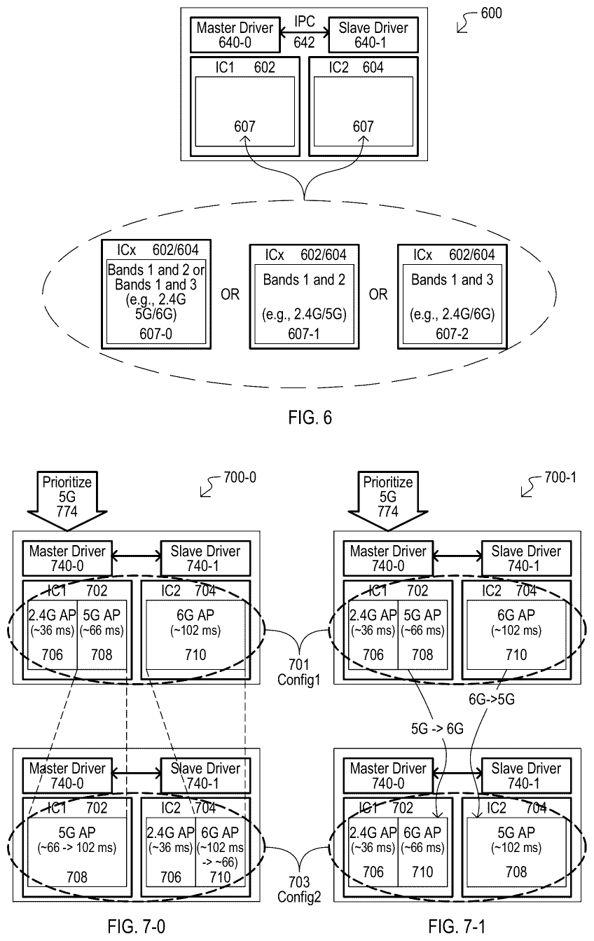

FIG. 6 is a block diagram of a system 600 according to another embodiment. In one embodiment, a system 600 can be one implementation of that shown in FIG. 1. A system 600 can be a tri-band system capable of prioritizing one band over the others by dynamically switching dual-band use across multiple ICs to dedicate greater resources and/or time allocation to one or more bands as compared to other bands.

A system 600 can include a master driver 640-0, a slave driver 640-1, an IC1 602 and an IC2 604. Master and slave drivers (640-0, 640-1) can be in communication with one another via IPC 642, and can take the form of any of those described herein or equivalents. IC1 602 and IC2 604 can have configuration options 607 that can enable an IC device (602 or 604) to be configured (and subsequently re-configured) between providing one access device (e.g., AP) on one band, or two access devices on two bands.

FIG. 6 shows three possible configuration options for ICs 602/604 that can be included in a system 600. Option 607-0 can be for an IC 602/604 that includes radio circuits for three different bands (e.g., 2.4, 5 and 6 GHz). Option 607-0 can enable dynamic switching between five different configurations: Single band operations on bands 1, 2 or 3, or dual band operations on bands 1 and 2 or on bands 1 and 3. Option 607-1 can be for an IC 602/604 that includes radio circuits for two different bands (e.g., 2.4 and 5 GHz). Option 607-1 can enable dynamic switching between three different configurations: Single band operations on bands 1 or 2, or dual band operations on bands 1 and 2. Option 607-2 can enable dynamic switching between three different configurations: Single band operations on bands 1 or 3, or dual band operations on bands 1 and 3. A system 600 can include an IC1 602 and IC2 604, where one IC has a configuration that includes a band 2 option (e.g., 607-0 or 607-1), while the other IC includes a band 3 option (e.g., 607-0 or 607-2) to enable tri-band operations.

In this way, a system can include two ICs that can switch between dual and single band operations to provide tri-band operations.

FIGS. 7-0 and 7-1 show how tri-band systems 700 can switch configurations to increase the priority of one band with respect to the others. FIGS. 7-0 and 7-1 show systems having items like those of FIG. 6, such like items are referred by the same reference characters but with the leading digit being “7” instead of a “6”.

Referring to FIG. 7-0, a system 700 can have a first configuration 701 in which IC1 702 can have a dual band configuration, which in the embodiment shown, can include the creation/existence of AP1 706 operating on a first band (in this case 2.4 GHz) and AP2 708 operating on a second band (in this case 5 GHz). IC2 704 can have a single band configuration, which in the embodiment shown, can include the creation/existence of AP3 710 operating on a third band (in this case 6 GHz). In some embodiments, IC1 702 can time multiplex between two portions of an operating interval (e.g., AP1 706 during ~36 ms of a ~102 ms interval, AP2 during ~66 ms of the ~102 ms interval).

Referring still to FIG. 7-0, in a first configuration 701, a system 700 can receive an indication 774 to prioritize (or otherwise increase) operations on a second band (e.g., 5 GHz). An indication 774 can originate from any other suitable process, including but not limited to: load balancing (e.g., spreading processing more evenly across bands), throughput adjustments (e.g., increasing or decreasing throughput on a band), or number of clients being supported (e.g., new client(s) being connected to one access device can exceed a maximum for the access device, client(s) be disconnected enables a lower throughput access device configuration to service clients).

Referring still to FIG. 7-0, following an indication to prioritize band 2 774, system 700 can be switched to a second configuration 703. By operation of master driver 740-0, IC1 702 can be re-configured to operate as an AP2 708 on band 2, and no longer operate as an AP1 on band 1. By operation of IPC 742 communications from master driver 740-0 to slave driver 740-1, IC2 704 can be re-configured to operate as an AP1 706 on band 1 and AP3 710 on band 3. In some embodiments, on IC1 702, AP2 708 can operate over an entire interval. On IC2 704, AP1 706 can operate during a first portion of an interval, while AP3 can operate during a second portion of an interval.

FIG. 7-1 shows a re-configuration like that of FIG. 7-0. However, unlike FIG. 7-0, following an indication to prioritize band 2 774, by operation of master driver 740-0, IC1 702 can be re-configured to operate as an AP1 706 on band 1 and an AP3 710 on band 3. By operation of IPC 742 communications from master driver 740-0 to slave driver 740-1, IC2 704 can be re-configured to operate as an AP2 708 on band 2. In some embodiments, on IC1 702, AP1 706 can operate during a first portion of an interval and AP3 can operate during a second portion of an interval. On IC1 702, AP2 708 can operate over an entire interval.

A re-configuration like that shown in FIG. 7-1 can be conceptualized as changing a time multiplexed AP operating on one band (AP2 on 5G) to a time multiplexed AP operating on another band (AP3 on 6G) (shown as 5G->6G). Similarly, a non-multiplexed AP operating on one band (AP3 on 6G) can be changed to a non-multiplexed AP operating on another band (AP2 on 5G) (shown as 6G->5G).

It is noted that in the embodiment of FIG. 7-1, IC1 702 and IC2 704 are both capable of providing operations on the second and third bands (e.g., 5 and 6 GHz). In contrast, an embodiment like that of FIG. 7-0, IC1 702 may not provide third band operations and IC2 704 may not provide second band operations. That is, in FIG. 7-0, IC1 702 can be configured as an AP for the 2.4 GHz and/or 5 GHz bands, but cannot be configured for a 6 GHz band. Similarly, IC2 704 can be configured as an AP for the 2.4 GHz and/or 6 GHz bands, but cannot support the 5 GHz band. In FIG. 7-1, IC1 and IC2 (702 and 704) are both capable of providing an AP in all three bands (2.4, 5 and 6 GHz).

In this way, a system providing tri-band operations with two ICs can reconfigure the two ICs to prioritize or otherwise alter the servicing of one band with respect to the other two bands.

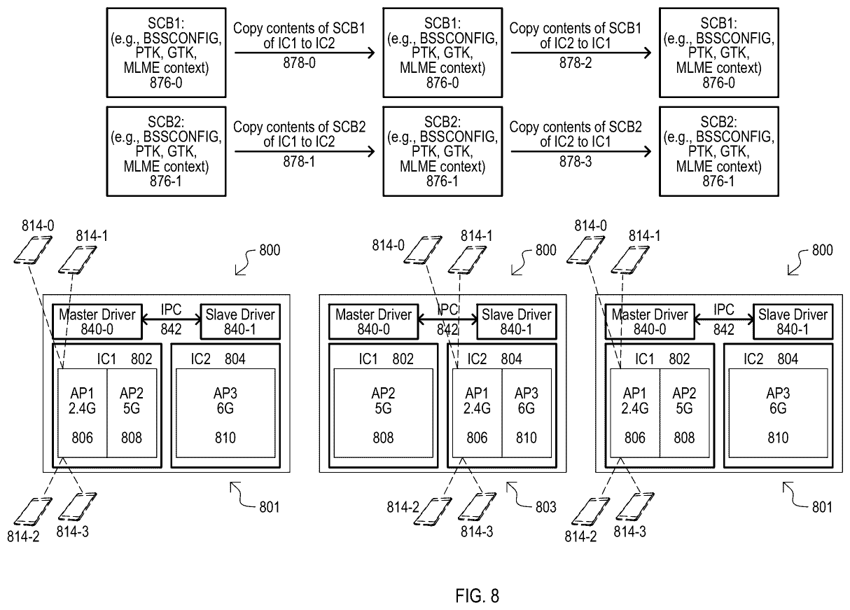

FIG. 8 is a diagram showing re-configuration of a system 800 according to another embodiment. In an embodiment, a system 800 and corresponding operations can be one implementation of that shown in FIG. 6. FIG. 8 can include items like those of FIG. 6, and such like items are referred to by the same reference characters but with the leading digit being an “8” instead of a “6”. FIG. 8 shows a system 800 in which configuration data can be copied from one IC to the other to enable an access device operating on one IC to be recreated (or switched or transferred) to the other IC.

Referring still to FIG. 8, a system 800 can be compatible with one or more IEEE 802.11 standards in which APs can be dynamically switched across two ICs. In the embodiment shown, this can include the copying of data for two system control blocks (SCBs).

FIG. 8 shows a system 800 in a first configuration 801, in which IC1 802 can be configured to with a 2.4 GHz AP1 806 and a 5 GHz AP2 808, while IC2 804 can be configured with a 6 GHz AP3. In some embodiments, AP1 806 and AP2 808 can time multiplex operations (e.g., 36 ms/66 ms), as described herein and equivalents. When AP1 806 is created, and while it operates, configuration data can be stored in IC1 802 as SCBs 876-0 and 876-1. In the embodiment shown, SCBs 876-0 and 876-2 can include basic service set configuration data (BSSCONFIG), encryption data (e.g., pairwise temporal keys (PTKs), groupwise temporal keys (GTK)), and MAC layer management entity (MLME) data. In a first configuration 801, four STAs (814-0, 814-1, 814-2, 814-2) (i.e., clients) can have established connections with AP1 806 on the 2.4 GHz band.

FIG. 8 shows copy operations 878-0, 878-1 that copy SCBs 876-0 and 876-1 from IC1 802 to IC2 804. In some embodiments, such an action can include a master driver 840-0 transferring SCB data (876-0, 876-1) to a slave driver 840-1 over IPC 842. Slave driver 840-1 can then write such configuration data to IC2 804. A system 800 can be placed in a second configuration 803, in which AP2 808 resides on IC1 802, while AP1 806 and AP3 810 can reside on IC2 804. As a result, clients (814-0, 814-1, 814-2, 814-3) can dynamically connect to AP1 806 on IC2 804. That is, IC2 804 can time multiplex operations between AP1 806 and AP3 810 (e.g., in a TDM fashion), while IC1 802 can provide AP2 808 in a non-time multiplexed fashion.

Configuration data can be copied back and forth between ICs. FIG. 8 showing copy operations 878-2, 878-3 that can copy SCBs (876-0, 876-1) back from IC1 802 to IC2 804, placing system 800 back into first configuration 801.

In some embodiments, configuration data can be copied in anticipation of the creation of a new AP on an IC. Then, when the AP from one IC is to be created on another IC, the other IC may already be in possession of the configuration data needed for the AP. In some embodiments, a portion of configuration data for an AP may be periodically copied from one IC to the other, with a final portion being copied upon creation of the new AP.

In this way, a tri-band system having a first IC time multiplexing between different wireless bands can dynamically switch configuration data from one IC to another to enable time multiplexing between APs on one IC to time multiplexing APs on another IC.

FIGS. 9-0 to 9-2 are diagrams of a system 900 and operations according to another embodiment. A system 900 can band steer a client connected on one band handled by one IC, to another band handled by another IC, when such a client emits requests with an anonymous identifier (e.g., random MAC address). In an embodiment, a system 900 and corresponding operations can be one implementation of that shown in FIG. 6. FIG. 8 can include items like those of FIG. 6, and such like items are referred to by the same reference characters but with the leading digit being a “9” instead of a “6”.

Unlike FIG. 6, a system 900 can include a connected list 984 that maintains identification values of clients that have connections with a system 900. In the embodiment shown, a system 900 can operate according to an IEEE 802.11 wireless standard (e.g., IEEE 802.11ax) in which STAs (i.e., clients) can issue requests (e.g., probes) with random MAC addresses.

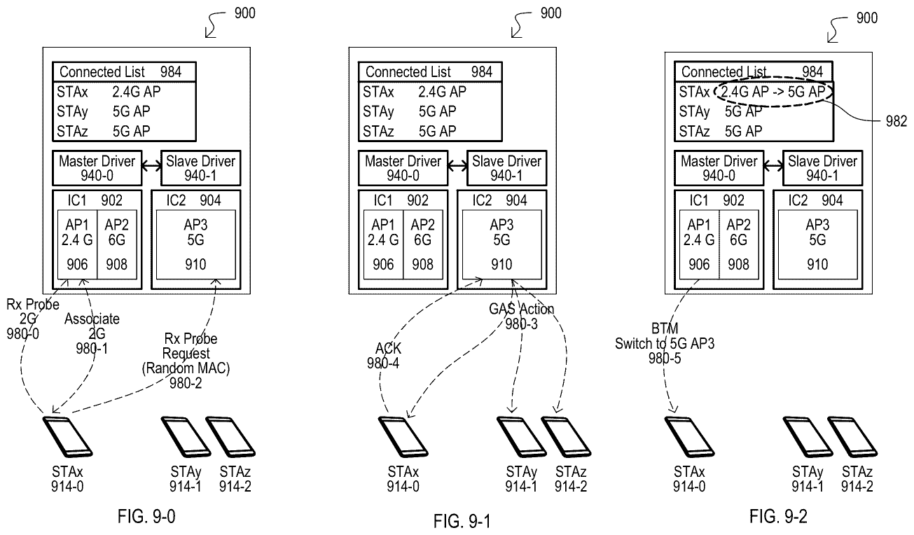

Referring to FIG. 9-0, a system 900 can include a client STAx 914-0 issuing a probe request 980-0 on a first band (e.g., 2.4 GHz) for association with AP1 906. In response to probe request 980-0, a STAx 914-0 can associate 980-1 with AP1 906 on a first band. After such association, STAx 914-0 can continue to issue requests (e.g., probes) on other bands, including a probe request 980-2 on a second band (5 GHz). However, such a probe request can have a random MAC address, and so STAx will not be known to AP3 910. Two other clients, STAy 914-1 and STAz 914-2, can already have connections with AP3 910 on a second band. Such connections can be maintained in a connected list 984.

Referring to FIG. 9-1, in response to receiving probe request 980-2, AP3 910 can access connected list 984 and issue a message 980-3 on a second band (e.g., 5G) for eliciting a response from STAs on connected list 984. In the embodiment shown, AP3 910 can issue a generic advertisement service (GAS) frame 980-3 to all devices on the connected list 984. In response to the GAS frame 980-3, STAx 914-0 can return an acknowledgement (ACK) 980-4 which can be received by AP3 910.

Referring to FIG. 9-2, in response to AP3 910 receiving ACK 980-4, a system 900 can issue a switch instruction 980-5 for the client (STAx 914-0) transmitting the ACK 980-4 to switch from its current band to the band on which the ACK 980-4 was received. In the embodiment shown, a switch instruction 980-5 can be a BSS transition management (BTM) frame. In response to such a frame, STAx 914-0 can switch from AP1 906 on a first band, to AP3 910 on a third band. Such a change can result in connected list 984 being updated.

In this way, a system can band steer client devices that utilize random MAC addresses on other bands.

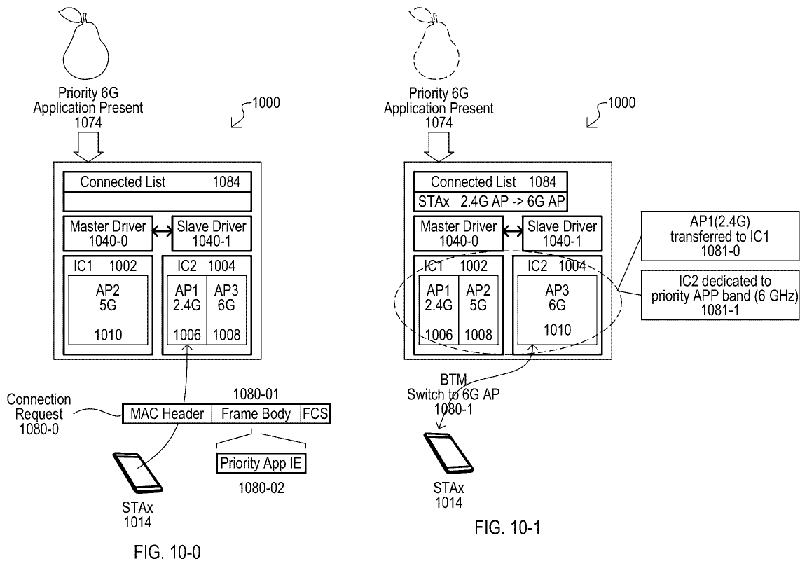

FIGS. 10-0 and 10-1 show a system 1000 and operations according to another embodiment. A system 1000 can include or be capable of running a priority application 1074. A priority application 1074 may refer to a primary application of a product (e.g., primary application of an infotainment system). When a client seeks to join (e.g., associate) with a system, it corresponding request (e.g., data frame) can be inspected to determine if the client is compatible with a priority application. If a client is compatible, a system can band steer the client to a band corresponding to the priority application. In some embodiments, a system can also dedicate an IC to the band serving the application (i.e., cease TDM operations). In an embodiment, a system 1000 and corresponding operations can be one implementation of that shown in FIG. 6. FIG. 10 can include items like those of FIG. 6, and such like items are referred to by the same reference characters but with the leading digits being “10” instead of a “6”.

Referring to FIG. 10-0, a system 1000 can be capable of running a priority application 1074. Further, a priority application 1074 can have a preferred band, which is 6 GHz in the embodiment shown, however in alternate embodiments, a preferred band could be any other band. In some embodiments, upon detecting a client capable of running a priority application, a system 1000 can start up the priority application (if not already active).

A client (STAx) 1014 can transmit a request 1080-0 to connect to a system 1000. Such a request 1080-0 can include information indicating that the client 1014 is compatible with the priority application 1074. In the embodiment of FIG. 10-0, a request 1080-0 can be data frame compatible with a IEEE 802.11 wireless standard that includes a Layer 2 frame body 1080-01 with one or more information elements (IEs) 1080-02 that indicate compatibility with the priority application 1074. In some embodiments, a STAx request 1080-0 can be on any of three bands (e.g., 2.4 G, 5 G, 6G). In the particular example of FIG. 10-0, request 1080-0 can be received by AP1 on the 2.5 GHz band.

Referring to FIG. 10-1, in response to STAx 1014 establishing a connection (e.g., associating) with system 1000, if STAx 1014 is not operating on a band of the preferred application 1074 (e.g., 6 GHz), STAx 1014 can be band steered to such a preferred band 1080-1. Such an action can take any suitable form, and in the embodiment shown, can include a BTM frame directing STAx 1014 to switch from the 2.4 GHz band serviced by AP1 1006 to the preferred 6 GHz band serviced by AP3 1010. Further, a system 1000 can transfer AP1 1006 to IC1 1002, and AP3 1010 can be configured to no longer operate in a TDM fashion. That is, IC2 1004 can be dedicated to AP3 1010 (i.e., the priority application's preferred band) In some embodiments, once STAx 1014 is disconnected and there are no other STAs connected that are compatible with the priority application, a system 1000 can return to time multiplexing the priority application band. For example, system 1000 can return to the configuration shown in FIG. 10-0.

In this way, a system can band steer client devices to and away from a band based on a priority application that makes use of the band.

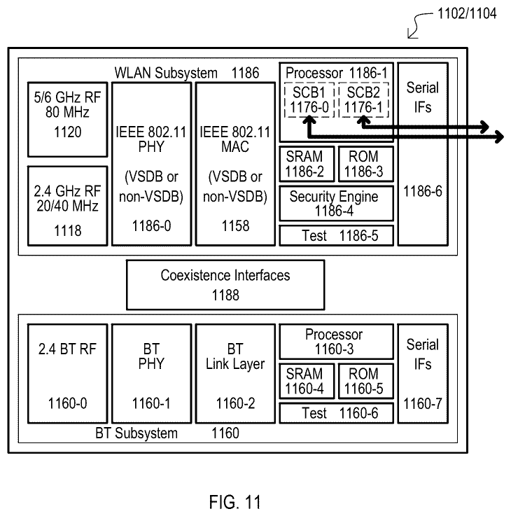

FIG. 11 is a block diagram of an IC according to an embodiment. In some embodiments, an IC 1102 (or 1104) can be a first or second IC for embodiments described herein and equivalents. An IC 1102 can include circuits formed with a same substrate. However, alternate embodiments can include multiple IC substrates integrated into a same IC package (e.g., multichip module).

An IC 1102 can include a WLAN subsystem 1186, a BT subsystem 1160 and coexistence interfaces 1188. A WLAN subsystem 1186 can provide wireless operations according to one or more IEEE 802.11 wireless standards, particularly standards that can operate across two bands. A WLAN subsystem 1186 can include first radio frequency (RF) circuits 1118, second RF circuits 1120, WLAN physical layer (PHY) circuits 1186-0, WLAN MAC layer circuits 1158, first processor circuits 1186-1, volatile memory circuits 1186-2, nonvolatile memory circuits 1186-3, security engine 1186-4, WLAN test circuits 1186-5, and WLAN serial IF circuits 1186-6.

First RF circuits 1118 can receive and transmit on a first band (e.g., 2.4 GHz). Second RF circuits 1120 can receive and transmit on a second band (e.g., 5 or 6 GHz).

WLAN PHY circuits 1186-0 can provide physical layer baseband operations for first and second bands according to one or more IEEE 802.11 wireless standards. WLAN MAC circuits 1158 can provide MAC layer operations first and second bands according to one or more IEEE 802.11 wireless standards. According to embodiments, WLAN MAC circuits 1158 can have at least two modes of operation. A first mode can operate on one band (e.g., non-VSDB). A second mode can time multiplex between first and second bands (e.g., VSDB) as described herein and equivalents.

WLAN processor circuits 1186-1 can control operations of WLAN subsystem 1186, including configuring and operating MAC layer circuits 1158 according to SCBs (1176-0 and 1176-1). According to embodiments, SCBs (1176-0 and 1176-1) can be transferred out of IC 1102 to another IC, or transferred into IC 1102 from another IC. Such a transfer of SCBs (1176-0 and 1176-1) enable the dynamic switching of access devices (e.g., APs) between ICs as described herein and equivalents.

Volatile memory circuits 1186-2 can take any suitable form, including but not limited to static random access memory (SRAM) or dynamic RAM (DRAM), including “pseudo” SRAM. Nonvolatile memory circuits 1186-3 can take any suitable form, including various forms of read only memory (ROM), including but not limited electrically programmable ROM (EPROM), electrically erasable programmable ROM (EEPROM), ferroelectric RAM (FRAM), and/or resistive RAM (RRAM). In some embodiments, nonvolatile memory circuits 1186-3 can store code for execution by WLAN processor circuits 1186-1 to control the various IC operations described herein and equivalents. In some embodiments, nonvolatile memory circuits 1186-3 can store SCBs (1176-0 and 1176-1).

Security engine 1186-4 can include circuits for accelerating security related operations, including but not limited to encryption, decryption and authentication. WLAN test circuits 1186-5 can enable testing of WLAN subsystem 1186, and in some embodiments can be compatible with one or more Joint Test Action Group (JTAG) standards.

WLAN serial IF circuits 1186-6 can enable communications with WLAN subsystem 1186, and in some embodiments, can enable the transfer of SCBs (1176-0 and 1176-1) between IC 1102 and another IC. WLAN serial IF circuits 1186-6 can be compatible with any suitable serial interface, including but limited to a PCIe standard and/or a SDIO standard.

A BT subsystem 1160 can provide operation according to one or more BT standards, and can include third RF circuits 1160-0, BT PHY circuits 1160-1, BT link layer circuits 1160-2, BT processor circuits 1160-3, BT volatile and nonvolatile memory circuits (1160-4 and 1160-5), BT test circuits 1160-6 and BT serial IF circuits 1160-7. Coexistence interfaces 1188 can enable WLAN subsystem 1186 and BT subsystem 1160 to coordinate transmissions over the first band (2.4 GHz) to avoid and/or otherwise reduce interference with one another.

In this way, an integrated circuit device can include a MAC layer circuit that can time multiplex operations between different band radio circuits.

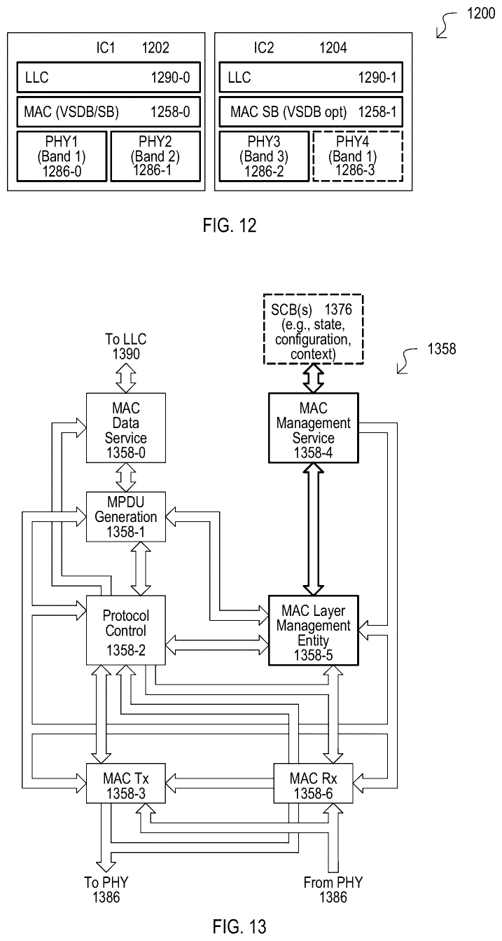

FIG. 12 is a diagram a system 1200 according to another embodiment. A system 1200 can include IC1 1202 and IC2 1204. IC1 1202 can include circuits (e.g., processing circuits) that operate with a logical link control network (LLC) layer 1290-0, MAC layer circuits 1258-0, first and second PHY circuits 1286-0 and 1286-1. MAC layer circuits 1258-0 of IC1 1202 can operate in a time multiplexed fashion between first PHY circuits 1286-0, operating on a first band, and second PHY circuits 1286-1 operating on a second band. MAC layer circuits 1258-0 can also operate in a single band fashion, operating only on a first band via first PHY circuit 1286-0, or operating on a second band via second PHY circuit 1286-1.

IC2 1204 can include LLC layer circuits 1290-1, MAC layer circuits 1258-1, and third PHY circuits 1286-2. MAC layer circuits 1258-1 can operate in a single band fashion on a third band with third PHY circuits 1286-2 Optionally, IC2 1204 can include fourth PHY circuits 1286-3 that can provide operations on a first band, in which case MAC layer circuits 1258-1 can also provide time multiplexed access to third and first bands via third and fourth PHY circuits 1286-2 and 1286-3.

In this way, a system can provide tri-band operations with two ICs that each include only one MAC layer circuit.

FIG. 13 is a block diagram of MAC layer circuits 1358 operations that can be included in embodiments. MAC layer circuits 1358 include an MLME 1358-5 that can operate according to configuration data 1376 (e.g., one or more SCBs). Such configuration data 1376 can result in MLME 1358-5 being dynamically configured to time multiplex operations between two different bands and/or be reconfigured between different access devices (e.g., APs) as described herein and equivalents.

In the embodiment shown, MAC layer circuits 1358 can provide configuration data to MLME 1358-5 with a MAC management service 1358-4. MAC layer circuits 1358 can further include a MAC data service 1358-0 that can receive data from an LLC layer 1390, MAC protocol data unit (MPDU) generation 1358-1, protocol control 1358-2 which can generate frames and route frames to other modules according to the protocol, a MAC transmission (Tx) operation 1358-3 which can provide data to PHY circuits 1386 and calculate transmission (e.g., back off times) times, and a MAC reception (Rx) operation 1358-6 that can receive data from PHY circuits 1386 and validate received frames, defragment frames, filter frames, and maintain a state of a channel.

It is understood that FIG. 13 shows but one implementation of a MAC layer circuit that can be included in embodiments, and should not be construed as limiting.

In this way, operations of an MLME of a MAC layer circuit can be changed in with configuration data to time multiplex access devices and/or re-create an access device that was present on a different IC.

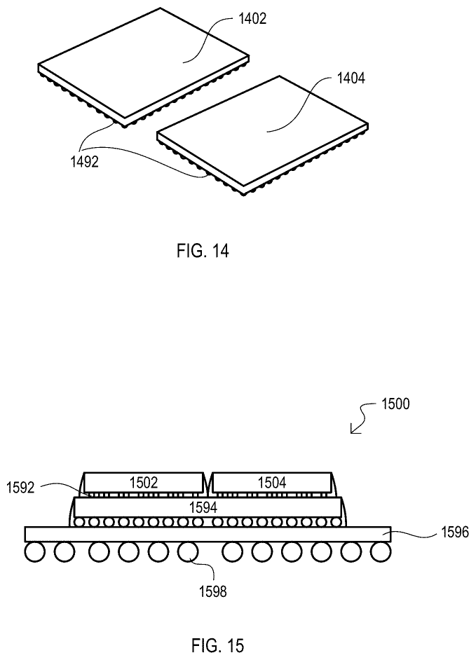

While systems and devices can include various interconnected components, embodiments can advantageously be compact having but two ICs. Between such two ICs, a device or system can provide tri-band operations, including operations that can transfer access devices (e.g., APs) between ICs. FIG. 14 show one example of two ICs that can provide tri-band operations according to an embodiment. A first IC 1402 can include wireless circuits for two bands, and in some embodiments can time multiplex between such bands. A second IC 1404 can include wireless circuits for at least a third band, or optionally, first and third bands. First and second ICs 1402 and 1404 can include physical connections (e.g., 1492) by which configuration data can be transferred between ICs (1402, 1404). While FIG. 14 shows ICs (1402, 1404) having a particular package type, embodiments anticipate any other suitable form, including individual die.

In this way, embodiments can include two IC devices that provide tri-band operations.

FIG. 15 is a side cross sectional view of a system 1500 according to another embodiment. A system 1500 can be a multichip module that includes an IC1 1502, IC2 1504, interposer 1594 and module substrate 1596. IC1 and IC2 (1502, 1504) can take the form of any of those described herein or equivalents. Interposer 1594 can provide signal paths between physical connections of IC1 and IC2 (1502, 1504), a s wells as physical connections with a module substrate 1596. Module substrate can include module physical connections (e.g., 1598).

In this way, embodiments can include a module with two IC devices that provide tri-band operations.

While devices and systems as described herein include the disclosure of various methods, additional methods will now be described with reference to flow diagrams.

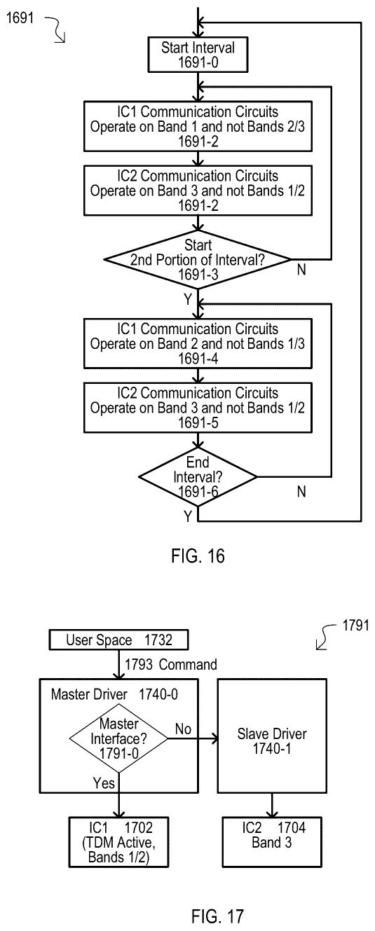

FIG. 16 is a flow diagram of a method 1691 according to an embodiment. A method 1691 can be executed by processing circuits of a system that includes an IC1 and IC2. A method 1691 can include a start of an interval 1691-0. An interval can be a repeating duration of time by which a wireless system can time operations. In some embodiments, an interval can be a TU according to a wireless standard. In some embodiments an interval can be a TU according to an IEEE 802.11 wireless standard having a duration of 1024 μs (e.g., ~102 ms). A start of an interval 1691-0 can also indicate the start of a first portion of an interval.

Following a start of an interval, a method can include IC1 communication circuits operating on a first band, but not on second or third bands 1691-2. In addition, IC2 communication circuits can operate on a third band, but not first and second bands. Such operations can continue (N from 1691-3) until the start of a second portion of the interval

Once a second portion of the interval as started (Y from 1691-3), a method 1691 can include IC1 communication circuits operating on a second band, but not on first or third bands 1691-4, while IC2 communication circuits can continue to operate on a third band, but not first and second bands 1691-5. Such operations can continue (N from 1691-6) until the end of the interval (1691-6), at which point a method 1691 can repeat.

In this way, a method can include a first IC that services a first band during a first portion of a time interval, and services a second band during a second portion of the interval. A second IC can service a third band during the first and second portions of the interval.

FIG. 17 is a flow diagram of a method 1791 according to another embodiment. A method 1791 can be executed on a system having an IC1 1702, IC2 1704, and processing circuits that execute a master driver process 1740-0 and slave driver process 1740-1. In some embodiments, a method 1791 can be executed by a system like that shown in FIG. 3. A first band access device (e.g., AP1 2.4 GHz) and second band access device (e.g., AP2 5 GHz) can be created on IC1 1702. A third band access device (e.g., AP3 6 GHz) can be created on IC2.

A method 1791 can include a command 1793 from a user space 1732 being generated, received, or otherwise occurring, and passed to a master driver process 1740-0. A command 1793 can be related to communications on one of first, second or third bands. Upon receiving command 1793, master driver process 1740-0 can determine whether or not the interface belongs to it (e.g., is for AP1 or AP2). If a command 1793 belongs to a master interface (Yes from 1791-0), a corresponding access device (e.g., AP1 or AP2) can be created on IC1 1702. In some embodiments, commands for bands 1 and 2 can be time multiplexed on IC1 1702, as described herein and equivalents.

If a command 1793 belongs to a slave interface (No from 1791-0), master driver process 1740-0 can forward the command to slave driver process 1740-1 (e.g., by using an IPC), and slave driver process 1740-1 can create an access device for band 3 (e.g., AP3) on IC2 1704.

In this way, in response to user space commands, a method can provide tri-band operations using two ICs.

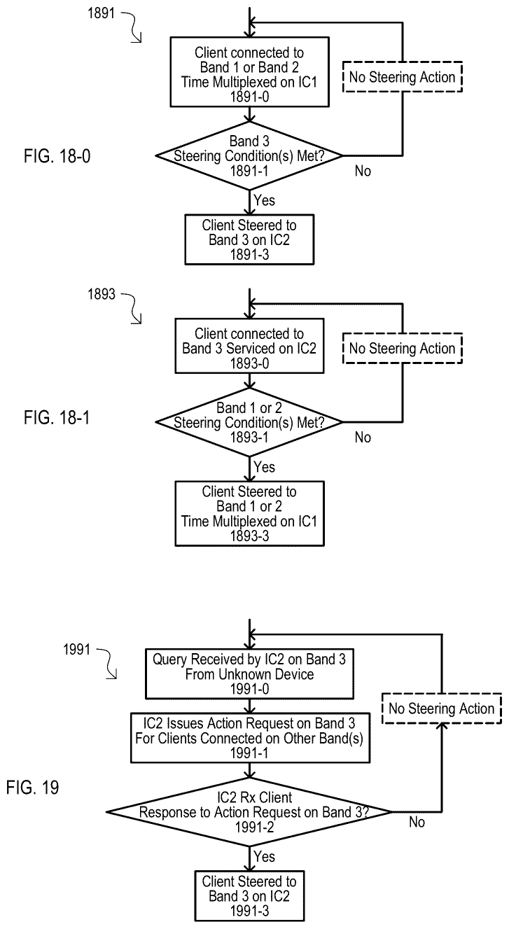

FIG. 18-0 is a flow diagram of a method 1891 according to a further embodiment. A method 1891 can be executed by processing circuits of a system that includes an IC1 that can time multiplex operations between a first and second band, and an IC2 that can provide wireless services on a third band. A method 1891 can band steer a client operating on a first or second band multiplexed by an IC1 to a third band provided by an IC2.

A method 1891 can include a client being connected to an access device of a first or second band, where such two bands are time multiplexed on IC1 1891-0. If conditions indicating a client should be steered to a third band are met (Yes from 1891-1), a method 1891 can steer the client to a third band on IC2 1891-3. A determination for a band steering operation can take any suitable form, including by not limited to load balancing, throughput adjustments, or limits on the number clients that can be connected on a band. Steering of a client can take any suitable form, and in some embodiments can include a BTM frame directing the client to an AP controlling access to the third band.

In this way, in response to predetermined steering conditions, a client can be steered from one of two bands that are time multiplexed with a first IC to a third band serviced by a second IC.

FIG. 18-1 is a flow diagram of a method 1893 according to a further embodiment. A method 1893 can be executed by processing circuits of a system as described for 18-0. A method 1893 can band steer a client operating on a third band serviced by an IC1, to a first or second band multiplexed by an IC2.

A method 1893 can include a client being connected to an access device of a third band of IC2 1893-0. If conditions indicating a client should be steered to a first or second band are met (Yes from 1893-1), a method 1893 can steer the client to such a first or second band on IC1 1893-3. Such a determination for band steering can take the form of any of those described herein or equivalents.

In this way, in response to predetermined steering conditions, a client can be steered from a band serviced by one IC to one of two bands that are time multiplexed on another IC.

FIG. 19 is a flow diagram of a method 1991 according to another embodiment. A method 1991 can be executed by processor circuits of a system that maintain a connected list identifying clients that are connected. In some embodiments, a method 1991 can be one implementation of that shown in FIGS. 9-0 to 9-2.

A method 1991 can include an IC2 receiving a query (e.g., probe request) on a third band from an unknown device 1991-0. In some embodiments, an unknown device can arise from an address (or other identifier) for the device being altered for security purposes. In some embodiments, a device can be unknown because it has generated a random address for its messages for security purposes, such as a random MAC address. In response to the query, an IC2 can issue an action request for clients connected on one or more other bands (e.g., Band 1 and/or Band 2) 1991-1. In some embodiments, one or more such other bands can be services by an IC1 of a same device as IC2.

If an IC2 receives a response (e.g., in the form of a MAC layer ACK) to the action request (Yes from 1991-2), such a client can be band steered to the third band 1991-3. If such a request is not received, no band steering can take place.

In this way, an IC device that receives a request on one band from an unknown device can issue an action request to clients connected on other bands by operation of another IC. If a client answer such a request, it can be steered to the one band.

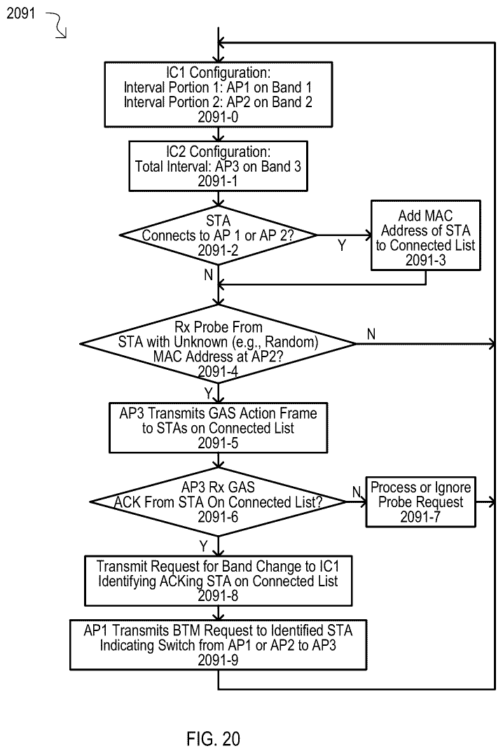

FIG. 20 is a flow diagram of a method 2091 according to another embodiment. A method 2091 can be executed by a system that includes two ICs, with which IEEE 802.11 compatible APs can be created, including in a time multiplexed fashion. In some embodiments, a method 2091 can be one implementation of that shown in FIGS. 9-0 to 9-1.

A method 2091 can include a first IC being in a first configuration, in which during a first portion of an interval (e.g., TU), an IC1 can include an AP1 operating on a first band, and during a second portion of an interval, IC1 can include an AP2 operating on a second band 2091-0. A second IC can have a first configuration that includes an AP3 operating on a third band during the interval 2091-1. A method 2091 can determine if a STA (e.g., client) has connected to AP1 or AP2 2091-2. If such a connection has been made, a MAC address of the STA can be added to a connected list 2091-3. Such an action can include storing the MAC address, and optionally other identifying data for the STA in memory.

A method 2091 can include determining if a probe has been received from a STA with an unknown MAC address at AP3 2091-4. If such a probe is received (Y from 2091-4), a method 2091-4 can include an AP3 transmitting a GAS action frame to STAs on a connected list 2091-5. Such a GAS action frame can request that STAs return an ACK. If such an ACK is not received (N from 2091-6), a method 2091 can ignore such a probe request and/or process such a request (e.g., as a STA seeking first association) 2091-7.

If such an ACK is received (Y from 2091-6), a method 2091 can include a request for a band change can be transmitted to IC1 that can identify the ACKing STA from the connected list 2091-8. In response, an AP1 2091-9 can transmit a BTM request to the identified STA that can indicate a switch from its current AP (i.e., AP1 or AP2) to AP3 2091-9.

In this way, a STA connected to on an AP created on one IC can issue random MAC address probe requests on other bands. If such a probe request is received by an AP created on another IC, such another AP can issue a GAS action frame to devices on a connected list. If a STA responds to the GAS action frame, it can be directed to change to the AP on the second IC.

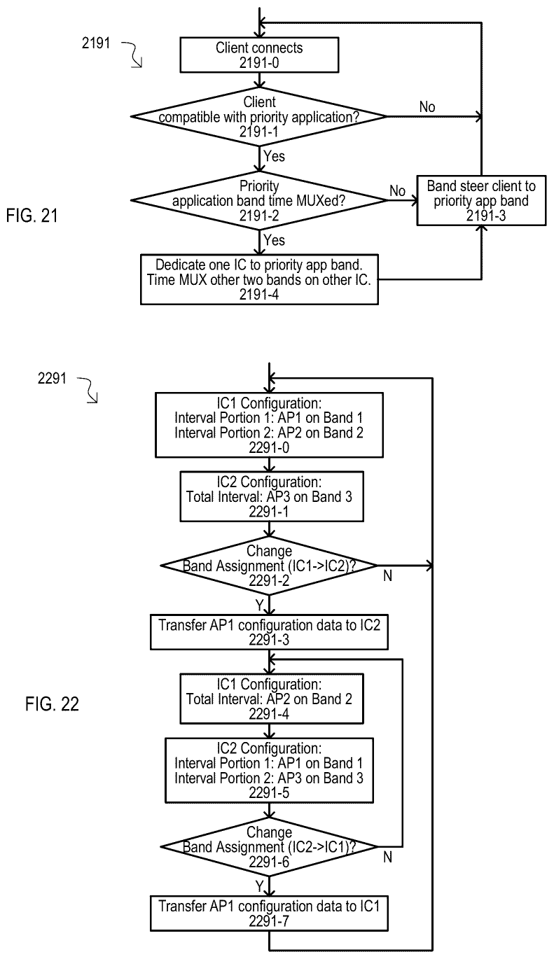

FIG. 21 is a flow diagram of a method 2191 according to another embodiment. A method 2191 can be executed by a system having processing circuits that can execute one or more applications that can be given priority use of one of multiple bands. A method 2191 can include a client connecting to a system 2191-0. Such an action can take any suitable form, including but not limited to, a STA transmitting an association request, and receiving an association response. A determination can be made as whether a client is compatible with a priority application 2191-2. Such an action can include examining data included in a client's request to connect to the system. In one embodiment, such an action can include a system examining an association request data frame for one or more IEs that indicate compatibility with a priority application. If a client is not compatible with a priority application (No from 2191-1), a method 2191 can continue servicing the connection. In some embodiments this can include band steering a client between bands as described herein and equivalents.

If a client is compatible with a priority application (Yes from 2191-1), a method 2191 can determine if a priority application band is currently being time multiplexed 2191-2. In some embodiments, such an action can include determining if an IC device is time multiplexing between two APs, as described herein or equivalents, and one of the APs is servicing the band preferred by the priority application. If the priority application band is not being time multiplexed (No from 2191-2), a method 2191 can band steer the client to the priority application band 2191-3 (if such a client is not already operating on the priority application band). If the priority application band is being time multiplexed (Yes from 2191-2), a method 2191 can dedicate one IC to the priority application band and time multiplex other bands on another IC 2191-4. A method 2191 can then band steer the client to the priority application band 2191-3.

In this way, a system can examine client requests, and if clients are compatible with a priority application, band steer the client to the priority application band. In addition or alternatively, if a priority application band is being time multiplexed at one IC, an IC can be dedicated to the priority application band, with other bands being time multiplexed on another IC of the system.

FIG. 22 is a flow diagram of a method 2291 according to another embodiment. A method 2291 can be executed by processing circuits of a system that includes two ICs, with which IEEE 802.11 compatible APs can be created, including in a time multiplexed fashion.

A method 2291 can include first and second ICs having a first configuration 2291-0 and 2291-1, with IC1 multiplexing AP1 and AP2, and IC2 including a AP3. If a change of band assignment from an IC1 to an IC2 is indicated (Y from 2291-2), a method 2291 can transfer AP1 configuration data to IC2 2291-2. Such an action can take the form of any of those described herein and equivalents. A change of band assignment can be in response to any of the various purposes described herein or equivalents. Following such a transfer of configuration data, IC1 and IC2 can have a new configuration.

In such a new configuration, a first IC can include AP2 operating on a second band during an interval 2291-4. A second IC can now include an AP1 operating on a first band during a first portion of an interval, and an AP3 operating on a third band during a second portion of the interval 2291-5. A method 2291 can determine if a reverse change of band assignment is indicated (i.e., from IC2 to an IC1). If such a band assignment is indicated (Y from 2291-6), a method 2291 can include transferring AP1 configuration data to IC1 2291-7.

In this way, a method can include transferring AP configuration data between IC devices to enable an AP created on one IC to be created on another IC of a same system.

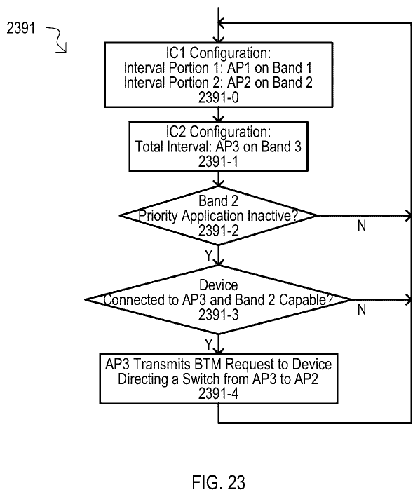

FIG. 23 is a flow diagram of a method 2391 according to another embodiment. A method 2391 can be executed by processing circuits of a system that includes an IC1 and IC2. A method 2391 can include first and second ICs having a first configuration 2391-0 and 2391-1, with IC1 multiplexing AP1 and AP2, and IC2 including an AP3. If an application that has priority access to a second band is not active (Y from 2391-2) and a device connected to AP3 is compatible with a second band (Y from 2391-3), a method 2391 can transmit a BTM frame to the device indicating a switch from AP3 to AP2 2391-4.

In this way, when a priority application is no longer using a band serviced by a particular IC, a STA connected to another IC on another band, can be connected to the particular IC.

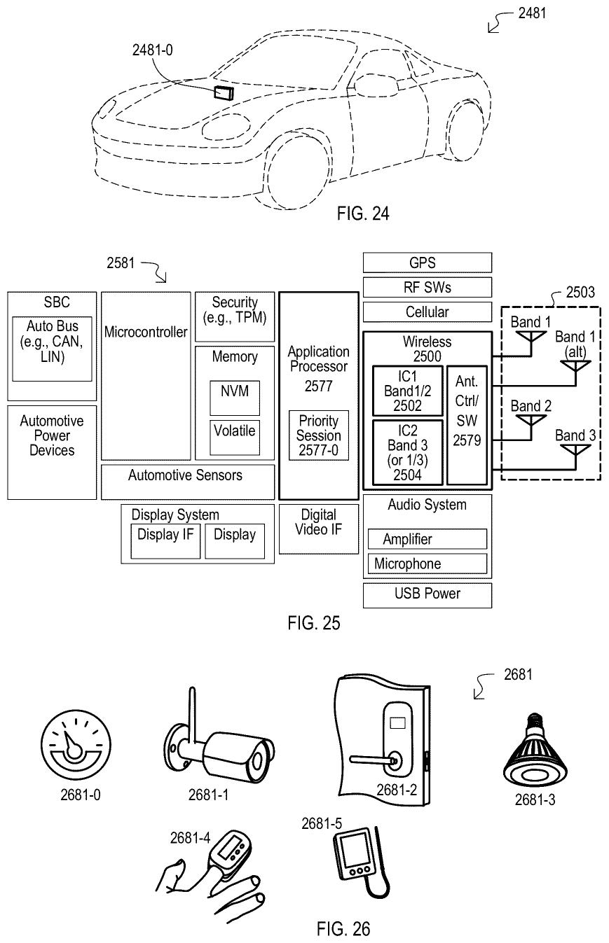

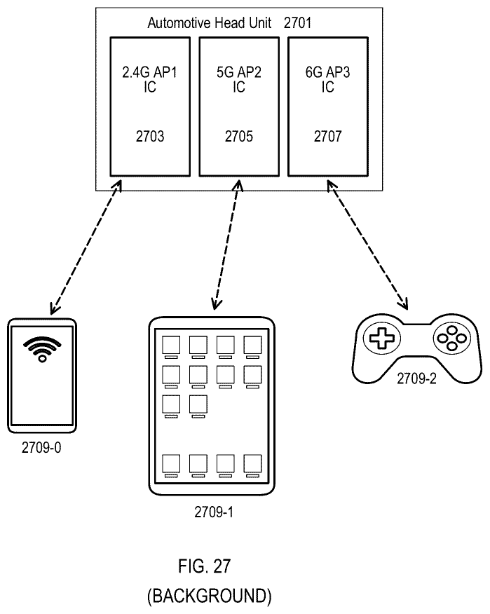

FIG. 24 is a diagram of an automobile system 2481 according to an embodiment. An automobile system 2481 can include an infotainment subsystem 2481-0 that can include an IC1 and IC2 as described for embodiments herein and equivalents. That is, subsystem 2481 can provide tri-band operations with two ICs, and can include the various operations described herein, including but not limited to band steering clients between different bands serviced by different ICs as well as the transfer of configuration data to enable an access device (e.g., AP) on one IC to be dynamically re-created/re-started on another IC.

FIG. 25 is a block diagram of an automobile system 2581 according to another embodiment. A system 2581 can include various components, including but not limited to a system basis chip (SBC), automotive power devices, automotive microcontroller, automotive sensors, security controller, memory circuits (e.g., nonvolatile (NVM) and volatile memory), automotive sensors, display systems, digital video interface, GPS, RF switches, cellular circuits, audio system (amplifier and microphone), and USB power.

A system 2581 can also include an application processor 2577, wireless subsystem 2500 and antenna subsystem 2503. An application processor 2577 can execute one or more priority sessions 2577-0 that can have priority over one or more bands, as described herein or equivalents. A wireless subsystem 2500 can include an IC1 2502, IC2 2504 and antenna control switches 2579. A wireless subsystem 2500 can take the form of various systems described herein and equivalents, including an IC1 2502 that can time multiplex between two bands, and an IC2 2504 that can operate on a third band. Antenna control switches 2579 can control access to antennas in antenna subsystem 2503. Antenna subsystem 2503 can include antennas for each three bands, Band 1, Band 2 and Band 3 serviced by wireless subsystem 2500.

In this way, an automobile can include a wireless system that can provide tri-band operations with two ICs.

FIG. 26 shows various other systems 2681 according to embodiments. Systems 2681 can include various wireless devices, such as industrial devices 2681-0 (e.g., gauges), security devices 2681-1 (e.g., cameras, alarms, sensors), home automation devices 2681-2/3 (e.g., locks, lighting, HVAC control), and medical devices 2681-4/5. Such wireless device (2681-0 to 2681-5) can be Internet-of-Things (IoT) type devices, and provide tri-band operations with two ICs as described for other embodiments herein and equivalents.

In this way, IoT devices can provide tri-band operations with two ICs, including band steering clients, and copying access devices from one IC to the other.

Embodiments can include methods, devices and systems can include configuring first wireless control circuits of a first IC to communicate according to at least a first wireless standard on a first wireless band during a first portion of a repeating operating interval, and communicate according to at least the first wireless standard on a second wireless band during a second portion of the operating interval that is different than the first portion. Second wireless control circuits of a second IC in communication with the first IC can be configured to communicate according to at least the first wireless standard in a third wireless band during the first and second operating intervals. The first wireless band, second wireless band and third wireless band can be frequency ranges that do not overlap one another.

Embodiments can include methods, devices and systems can have a first IC that includes first wireless control circuits configured to communicate according to at least a first wireless standard in a first wireless band during a first portion of a repeating operating interval, and communicate according to at least the first wireless standard in a second wireless band during a second portion of the operating interval that is different than the first portion. A second IC can be in communication with the first IC over a wired connection and can include second wireless control circuits configured to communicate according to at least the first wireless standard in a third wireless band during the first and second operating intervals.

Embodiments can include methods, devices and systems having a wireless subsystem with a first AP and a second AP comprising a first integrated circuit device (IC). A first AP can operate on a first wireless band during a first portion of a repeating operating interval, and a second AP can operate on a second wireless band during a second portion of the operating interval that is different than the first portion. A third AP can include a second IC coupled to the first IC by a wired connection. A third AP can operate on a third wireless band during the first and second operating intervals. An antenna subsystem can be coupled to the wireless subsystem that includes a first antenna configured for the first wireless band, a second antenna configured for the second wireless band, and a third antenna configured for the third wireless band. A first wireless band, second wireless band, and third wireless band may not overlap one another.

Methods, devices and systems according to embodiments can include, in response to predetermined operating conditions, re-configuring the first wireless control circuits to communicate according to the first wireless standard in the second wireless band during the first and second portions of the operating interval. In addition, second wireless control circuits can be configured to communicate according to at least the first wireless standard in the first wireless band during the first portion of the operating interval, and communicate according to at least the first wireless standard in the third wireless band during the second portion of the operating interval.

Methods, devices and systems according to embodiments can include, when re-configuring the second wireless control circuits, transferring control data via a wired communication path between the first IC and the second IC. Control data can include configuration data, and encryption keys corresponding to wireless connections to the first IC over the first wireless band. Methods, devices and systems according to embodiments can include first wireless control circuits including first MAC layer circuits for a first AP operating on the first wireless band and a second AP operating on the second wireless band. Second wireless control circuits can include second MAC layer circuits of a third AP operating on the third wireless band. Configuration data can include MAC layer management entity state data for the first MAC layer circuits. Encryption keys can include a pairwise transient key and group temporal key.

Methods, devices and systems according to embodiments can include, in response to at least one predetermined condition of the first or second IC, by operation of the first wireless control circuits, transmitting a management request over the first wireless band directing a wireless device to change a wireless connection to the first IC over the first wireless band, to a new wireless connection to the second IC over the third wireless band.

Methods, devices and systems according to embodiments can include maintaining a connected list of IDs of wireless devices with established wireless connections to the first IC over at least the first band. In response to detecting a predetermined request from a wireless device over the third band, by operation of the second wireless control circuits, an action communication can be transmitted to wireless devices on the connected list. The action communication can be configured to elicit a predetermined response on the third band. In response to receiving the predetermined response from a wireless device on the connection list over the third band, by operation of the first wireless circuits, transmitting a management request over the first wireless band directing the wireless device to switch a wireless connection to the first IC over the first wireless band, to a new wireless connection to the second IC over the third wireless band.

Methods, devices and systems according to embodiments can include, at least a first wireless standard being an IEEE 802.11 wireless standard. A predetermined request can include a probe request with a random MAC address. An action communication include a general service advertisement action frame. A management request can include a BTM request.

Methods, devices and systems according to embodiments can include, first and second ICs that are part of a system configured to intermittently execute an application that operates on the second wireless band. A determination can be made that at least one wireless device is connected to the second IC over the third wireless band and is capable of operating on the second wireless band. In response to determining that the application is not being executed by the system, a management request can be transmitted over the third wireless band directing the at least one wireless device to change its wireless connection to a wireless connection to the first IC over the second wireless band.

Methods, devices and systems according to embodiments can include, first wireless control circuits configured to, in response to at least one predetermined state of the device, communicate according to at least the first wireless standard in the second wireless band during the first and second portions of the operating interval. Second wireless control circuits can be configured to, in response to the at least one predetermined state of the device, communicate according to at least the first wireless standard in the first wireless band during the first portion of the operating interval, and communicate according to at least the first wireless standard in the third wireless band during the second portion of the operating interval.

Methods, devices and systems according to embodiments can include memory circuits configured to store a connected list of IDs of wireless devices with established wireless connections to the first IC over at least the first band. First wireless circuits can be configured to, in response to receiving a change request from the second IC over the wired connection, transmit a management request over the first wireless band addressed to the device ID of a wireless device. A management request can direct a wireless device to switch a wireless connection to the first IC over the first wireless band, to a new wireless connection to the second IC over the third wireless band.

Methods, devices and systems according to embodiments can include a first IC having first radio circuits configured to receive and transmit over the first wireless band, and second radio circuits configured to receive and transmit over the second wireless band. A second IC can include third radio circuits configured receive and transmit over a third wireless band.

Methods, devices and systems according to embodiments can include a first wireless standard being an IEEE 802.11 wireless standard. First wireless control circuits can include first MAC layer circuits for a first AP operating on the first wireless band and a second AP operating on the second wireless band. Second wireless control circuits can include second MAC layer circuits of a third AP operating on the third wireless band. A first wireless band, second wireless band and third wireless band can be from the group of: 2.4 GHz, 5 GHz and 6 GHz ISM bands.

Methods, devices and systems according to embodiments can include a wireless subsystem is further configured to, in response to at least one predetermined system state, reconfigure the first AP to operate on the second IC during the first portion of the operating interval, reconfigure the second AP to operate during the first portion and second portion of the operating interval, and reconfigure the third AP to operate during the second portion of the operating interval.

Methods, devices and systems according to embodiments can include a wireless subsystem having storage circuits for storing device IDs of wireless devices connected to the first AP. A first AP can be configured to, in response to receiving a change request from the third AP over the wired connection, transmit a management request to the device ID of one of the wireless devices. A management requesting can direct the one wireless device to switch a wireless connection to the first AP, to a new wireless connection to the third AP.

Methods, devices and systems according to embodiments can include a system intermittently executing an application that operates on the second wireless band. A third AP can be configured to, in response to a determination that at least one wireless device connected to the third AP and is capable of operating on the second wireless band and the application is inactive, transmit a management request directing the at least one wireless device to change its wireless connection to the second AP.

Methods, devices and systems according to embodiments can include an automotive infotainment head unit.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
configuring first wireless control circuits of a first integrated circuit device (IC) to
communicate according to at least a first wireless standard on a first wireless band during a first portion of a repeating operating interval, and
communicate according to at least the first wireless standard on a second wireless band during a second portion of the operating interval that is different than the first portion; and
configuring second wireless control circuits of a second IC in communication with the first IC to communicate according to at least the first wireless standard in at least a third wireless band during the first and second operating intervals; wherein
the first wireless band, second wireless band and third wireless band comprise frequency ranges that do not overlap one another.

2. The method of claim 1, further including:
in response to predetermined operating conditions
re-configuring the first wireless control circuits to communicate according to the first wireless standard in the second wireless band during the first and second portions of the operating interval; and
re-configuring the second wireless control circuits to
communicate according to at least the first wireless standard in the first wireless band during the first portion of the operating interval, and
communicate according to at least the first wireless standard in the third wireless band during the second portion of the operating interval.

3. The method of claim 2, wherein:
re-configuring the second wireless control circuits includes transferring control data via a wired communication path between the first IC and the second IC, the control data including
configuration data for configuring wireless circuits, and
encryption keys corresponding to wireless connections to the first IC over the first wireless band.

4. The method of claim 3, wherein
first wireless standard comprises an IEEE 802.11 wireless standard;
the first wireless control circuits comprise first media access control (MAC) layer circuits for a first access point device (AP) operating on the first wireless band and a second AP operating on the second wireless band;
the second wireless control circuits comprise second MAC layer circuits of a third AP operating on the third wireless band;
the configuration data comprises MAC layer management entity state data for the first MAC layer circuits; and
the encryption keys comprise a pairwise transient key and group temporal key.

5. The method of claim 1, further including:
in response to at least one predetermined condition of the first or second IC, by operation of the first wireless control circuits, transmitting a management request over the first wireless band directing a wireless device to change a wireless connection to the first IC over the first wireless band, to a new wireless connection to the second IC over the third wireless band.

6. The method of claim 1, further including:
maintaining a connected list of identification values (IDs) of wireless devices with established wireless connections to the first IC over at least the first band;
in response to detecting a predetermined request from a wireless device over the third band, by operation of the second wireless control circuits, transmitting an action communication to wireless devices on the connected list, the action communication configured to elicit a predetermined response on the third band; and
in response to receiving the predetermined response from a wireless device on the connection list over the third band, by operation of the first wireless circuits, transmitting a management request over the first wireless band directing the wireless device to switch a wireless connection to the first IC over the first wireless band, to a new wireless connection to the second IC over the third wireless band.

7. The method of claim 6, further including:
the at least first wireless standard is at least one IEEE 802.11 wireless standard;
the predetermined request comprises a probe request with a random MAC address;
the action communication comprises a generic advertisement service frame; and
the management request comprises a basic service set transition management request.

8. The method of claim 1, further including:
the first and second ICs are part of a system configured to intermittently execute an application that operates on the second wireless band;
determining that at least one wireless device is connected to the second IC over the third wireless band and is capable of operating on the second wireless band; and
in response to determining that the application is not being executed by the system, transmitting a management request over the third wireless band directing the at least one wireless device to change its wireless connection to a wireless connection to the first IC over the second wireless band.

9. The method of claim 1, wherein:
the first wireless band, second wireless band and third wireless band are selected from the group of: the 2.4 GHz, 5 GHz and 6 GHz ISM bands.

10. A device, comprising:
a first integrated circuit device (IC) that includes
first wireless control circuits configured to
communicate according to at least a first wireless standard in a first wireless band during a first portion of a repeating operating interval, and
communicate according to at least the first wireless standard in a second wireless band during a second portion of the operating interval that is different than the first portion; and
a second IC in communication with the first IC over a wired connection that includes second wireless control circuits configured to communicate according to at least the first wireless standard in a third wireless band during the first and second operating intervals.

11. The device of claim 10, wherein:
the first wireless control circuits are further configured to, in response to at least one predetermined state of the device, communicate according to at least the first wireless standard in the second wireless band during the first and second portions of the operating interval; and
the second wireless control circuits are further configured to, in response to the at least one predetermined state of the device,
communicate according to at least the first wireless standard in the first wireless band during the first portion of the operating interval, and
communicate according to at least the first wireless standard in the third wireless band during the second portion of the operating interval.

12. The device of claim 10, further including:
memory circuits configured to store a connected list of identification values (IDs) of wireless devices with established wireless connections to the first IC over at least the first band; and
the first wireless circuits are further configured to, in response to receiving a change request from the second IC over the wired connection, transmit a management request over the first wireless band addressed to the device ID of a wireless device, the management request directing the wireless device to switch a wireless connection to the first IC over the first wireless band, to a new wireless connection to the second IC over the third wireless band.

13. The device of claim 10, wherein:
the device includes processor circuits that intermittently execute an application that operates on the second wireless band; and
the second wireless control circuits are further configured to, in response to a determination that at least one wireless device is connected the second IC over the third wireless band and is capable of operating on the second wireless band and the application is inactive, transmit a management request over the third wireless band directing the at least one wireless device to change its wireless connection to a wireless connection to the first IC over the second wireless band.

14. The device of claim 10, wherein:
the first IC further includes
first radio circuits configured to receive and transmit over the first wireless band, and
second radio circuits configured to receive and transmit over the second wireless band; and
the second IC includes third radio circuits configured receive and transmit over the third wireless band.

15. The device of claim 10, wherein:
the first wireless standard comprises an IEEE 802.11 wireless standard;
the first wireless control circuits comprise first media access control (MAC) layer circuits for a first access point device (AP) operating on the first wireless band and a second AP operating on the second wireless band;
the second wireless control circuits comprise second MAC layer circuits of a third AP operating on the third wireless band; and
the first wireless band, second wireless band and third wireless band are selected from the group of: 2.4 GHz, 5 GHz and 6 GHz ISM bands.

16. A system, comprising:
a wireless subsystem that includes
a first access point device (AP) and a second AP comprising a first integrated circuit device (IC),
the first AP operating on a first wireless band during a first portion of a repeating operating interval, and
the second AP operating on a second wireless band during a second portion of the operating interval that is different than the first portion; and
a third AP comprising a second IC coupled to the first IC by a wired connection, the third AP operating on a third wireless band during the first and second operating intervals; and
an antenna subsystem coupled to the wireless subsystem that includes a first antenna configured for the first wireless band, a second antenna configured for the second wireless band, and a third antenna configured for the third wireless band; wherein
the first wireless band, second wireless band, and third wireless band do not overlap one another.

17. The system of claim 16, wherein:
the wireless subsystem is further configured to, in response to at least one predetermined system state,
reconfigure the first AP to operate on the second IC during the first portion of the operating interval,
reconfigure the second AP to operate during the first portion and second portion of the operating interval, and
reconfigure the third AP to operate during the second portion of the operating interval.

18. The system of claim 16, wherein:
the wireless subsystem further includes
storage circuits for storing device IDs of wireless devices connected to the first AP,
the first AP is configured to in response to receiving a change request from the third AP over the wired connection, transmit a management request to the device ID of one of the wireless devices, the management requesting directing the one wireless device to switch a wireless connection to the first AP, to a new wireless connection to the third AP.

19. The system of claim 10, wherein:
the system intermittently executes an application that operates on the second wireless band; and
the third AP is configured to, in response to a determination that at least one wireless device connected to the third AP and is capable of operating on the second wireless band and the application is inactive, transmit a management request directing the at least one wireless device to change its wireless connection to the second AP.

20. The system of claim 16, wherein the system comprises an automotive infotainment head unit.
